(19) United States
(12) Patent Application Publication
(10) Pub. No.: US 2015/0341678 A1
(43) Pub. Date: Nov. 26, 2015

(54) VIDEO SUPPLY APPARATUS, VIDEO OBTAINING APPARATUS, CONTROL METHODS THEREOF, AND VIDEO SUPPLY SYSTEM

(71) Applicant: CANON KABUSHIKI KAISHA, Tokyo (JP)

(72) Inventor: Toshinori Koba, Kawasaki-shi (JP)

(21) Appl. No.: 14/708,737

(22) Filed: May 11, 2015

(30) Foreign Application Priority Data
May 20, 2014 (JP) 2014-104508

(51) Int. Cl. H04N 21/234; H04N 21/4147; H04N 21/262; H04N 21/6437; H04N 21/2187

(52) U.S. Cl. CPC H04N 21/234; H04N 21/6437; H04N 21/2187; H04N 21/26258; H04N 21/4147

(57) ABSTRACT

A video supply apparatus for streaming video data to an external apparatus comprises: a segment generation unit generating a segment representing a part of the video data; an obtaining information generation unit generating obtaining information used by the external apparatus; a list sending unit sending a list including the obtaining information to the external apparatus; and a segment sending unit sending the segment, the apparatus further comprising an obtaining unit obtaining information representing a usage type of the video data, wherein if the information represents a first type, the list sending unit sends the list that includes the obtaining information about a latest segment, and if the information represents a second type, the list sending unit sends the list that includes the obtaining information about the latest segment and the other segment unsent.

### BACKGROUND OF THE INVENTION

1. Field of the Invention

The present invention relates to a video supply apparatus, a video obtaining apparatus, control methods thereof, and a video supply system and, more particularly, to a video streaming technique.

2. Description of the Related Art

Out of streaming techniques of downloading video or audio data and reproducing it at the same time, a live streaming technique is known in which a distribution side encodes and distributes a video or audio in real time. Focusing real-time processing, the conventional live streaming technique generally uses RTP (Realtime Transport Protocol) using UDP (User Datagram Protocol). However, this technique may cause data loss or the like because data reach is not guaranteed, and this technique is therefore unsuitable to, for example, record streaming data of a video or music by a reception terminal. To solve this problem, there is proposed a camera for sending a video via a network, which switches, based on an instruction of a client, between a normal mode in which a shot video is continuously sent and a file transfer mode in which a video is temporarily stored in a file and then transferred (Japanese Patent Laid-Open No. 2007-158552). In this technique, streaming data is sent to the client in the normal mode when the load on the network is light, and a file in which data is stored in advance is transferred when the load on the network is heavy, thereby allowing the client to obtain data without loss. For this reason, when recording a long-time video, time is taken to store and transfer the file, resulting in loss of real-time processing.

On the other hand, there are also proposed live streaming techniques for transferring divided low-capacity files using TCP (Transmission Control Protocol) and HTTP (HyperText Transfer Protocol). One of the streaming methods uses a segment formed by dividing streaming data into low-capacity files of a predetermined time and a playlist (also called an index file) that describes the information of the segment. In this streaming method, a server and a client, which are connected via a network, transfer data described in a playlist. First, the server divides streaming data into segments, and creates a playlist that describes the obtaining destination of the segments. When distributing a video live, segment data is generated periodically. When a new segment is generated, the server dynamically updates the playlist (by deletion or addition) to a playlist of new contents (also called a slide window playlist). The client obtains and analyzes the playlist sent from the server and obtains the segments from the obtaining destination in the order listed in the playlist. The client reproduces or stores the obtained segment data and obtains a playlist again.

In the above-described streaming method using a playlist, low-capacity files are transferred using a method that guarantees data reach. For this reason, if old segments delayed because of the network condition are accumulated, the information amount of the playlist that describes the obtaining destination of the segments increases. In a usage pattern (type) where the client does not necessarily receive all segments (for example, in live view that prioritizes minimizing delay), sending or receiving a playlist including the obtaining destination of unnecessary old segments wastefully consumes the band. Especially when the playlist is updated and sent at a very short interval, an increase in the information amount of the playlist and band consumption caused by the increase become conspicuous. In addition, when segments are accumulated, buffer usage in the server increases. If the client does not obtain the segments accumulated in the buffer, the corresponding buffer capacity is wastefully occupied.

### SUMMARY OF THE INVENTION

The present invention has been made in consideration of the aforementioned problems, and realizes a technique of enabling a receiving-side apparatus to efficiently generate information to obtain streaming data.

In order to solve the aforementioned problems, the present invention provides a video supply apparatus for streaming video data to an external apparatus, comprising: a segment generation unit configured to generate a segment representing a part of a predetermined time length of the video data; an obtaining information generation unit configured to generate obtaining information used by the external apparatus to obtain the segment; a list sending unit configured to send a list including the obtaining information to the external apparatus; and a segment sending unit configured to send, to the external apparatus, the segment requested by the external apparatus using the obtaining information, the apparatus further comprising an obtaining unit configured to obtain information representing a usage type of the video data from the external apparatus, wherein if the information representing the usage type of the video data represents a first type, the list sending unit sends the list that includes the obtaining information about a latest segment but does not include the obtaining information about another segment unsent to the external apparatus, and if the information representing the usage type of the video data represents a second type, the list sending unit sends the list that includes the obtaining information about the latest segment and the obtaining information about the other segment unsent to the external apparatus.

In order to solve the aforementioned problems, the present invention provides a video obtaining apparatus comprising: a list receiving unit configured to receive, from a video supply apparatus for streaming video data, a list including obtaining information used to obtain a segment representing a part of a predetermined time length of the video data; a request unit configured to request the segment from the video supply apparatus using the obtaining information; a segment receiving unit configured to receive the requested segment, the apparatus further comprising a type sending unit configured to send information representing a usage type of the video data to the video supply apparatus, wherein the information representing the usage type of the video data includes one of a first type that prioritizes minimizing delay rather than minimizing loss of the video data and a second type that prioritizes minimizing loss rather than minimizing delay of the video data.

In order to solve the aforementioned problems, the present invention provides a control method of a video supply apparatus for streaming video data to an external apparatus, comprising: a segment generation step of generating a segment representing a part of a predetermined time length of the video data by a segment generation unit; an obtaining information generation step of generating obtaining information used by the external apparatus to obtain the segment; a list sending step of sending a list including the obtaining information to the external apparatus by a list sending unit; and a segment sending step of sending, to the external apparatus, the segment requested by the external apparatus using the obtaining information, the method further comprising an obtaining step of obtaining information representing a usage type of the video data from the external apparatus of a streaming destination, wherein in the list sending step, if the information representing the usage type of the video data represents a first type, the list that includes the obtaining information about a latest segment but does not include the obtaining information about another segment unsent to the external apparatus is sent to the external apparatus, and if the information representing the usage type of the video data represents a second type, the list that includes the obtaining information about the latest segment and the obtaining information about the other segment unsent to the external apparatus is sent to the external apparatus.

In order to solve the aforementioned problems, the present invention provides a control method of a video obtaining apparatus, comprising: a list receiving step of receiving, from a video supply apparatus for streaming video data, a list including obtaining information used to obtain a segment representing a part of a predetermined time length of the video data; a request step of requesting the segment from the video supply apparatus using the obtaining information; a segment receiving step of receiving the requested segment, the method further comprising a type sending step of sending information representing a usage type of the video data to the video supply apparatus, wherein the information representing the usage type of the video data includes one of a first type that prioritizes minimizing delay rather than minimizing loss of the video data and a second type that prioritizes minimizing loss rather than minimizing delay of the video data.

According to the present invention, a receiving-side apparatus can efficiently generate information to obtain streaming data.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIGS. 1A and 1B are block diagrams showing examples of the functional arrangements of a digital camera and a mobile phone according to an embodiment of the present invention;

FIG. 2 is a view showing the outline of processing between the digital camera and the mobile phone according to the embodiment;

FIGS. 3A and 3B are views showing a screen displayed on the mobile phone according to the embodiment and an example of a playlist;

FIGS. 4A and 4B are views showing an example of playlists according to the embodiment including a congestion time;

FIG. 5 is a flowchart showing a series of operations of processing of the digital camera according to the embodiment; and

FIG. 6 is a flowchart showing a series of operations of processing of the mobile phone according to the first embodiment of the present invention.

### DESCRIPTION OF THE EMBODIMENTS

### First Embodiment

An exemplary embodiment of the present invention will now be described in detail with reference to the accompanying drawings. Note that a video supply system formed from a video supply apparatus and a video obtaining apparatus will be described below. As an example of the video supply apparatus, an example in which the present invention is applied to an arbitrary digital camera capable of supplying live streaming data will be described. However, the present invention is applicable not only to the digital camera but also to any other arbitrary device that can supply live streaming data when connected to a video obtaining apparatus. These devices can include, for example, a mobile phone, game machine, tablet terminal, personal computer, and watch-type or glass-type information terminal. As an example of the video obtaining apparatus for obtaining live streaming data, an example in which the present invention is applied to a mobile phone will be described. However, the present invention is applicable not only to the mobile phone but also to any other arbitrary video obtaining apparatus capable of obtaining live streaming data when connected to an external apparatus. These devices can include a game tablet, tablet terminal, personal computer, and watch-type or glass-type information terminal.

(Arrangements of Digital Camera 1000 and Mobile Phone)

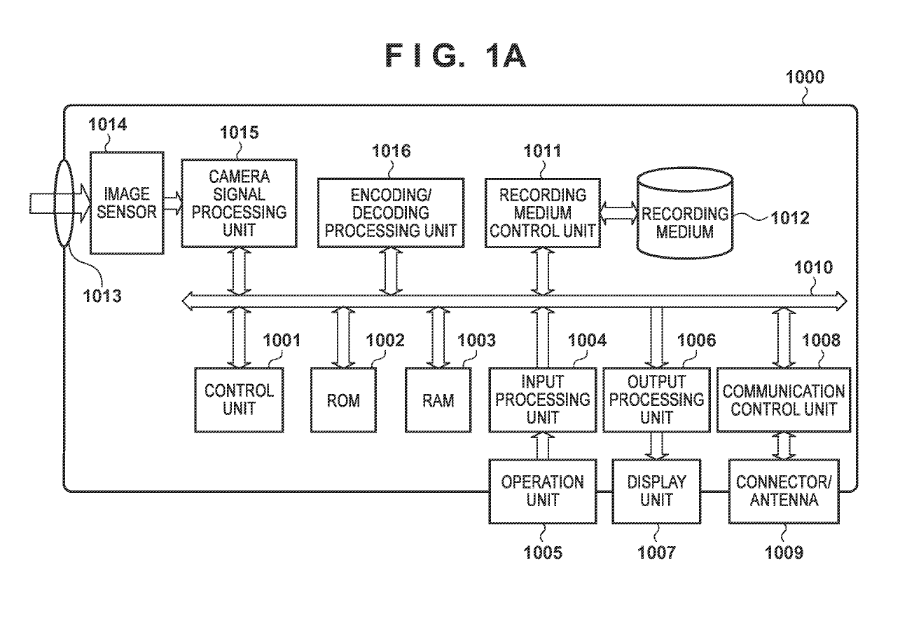

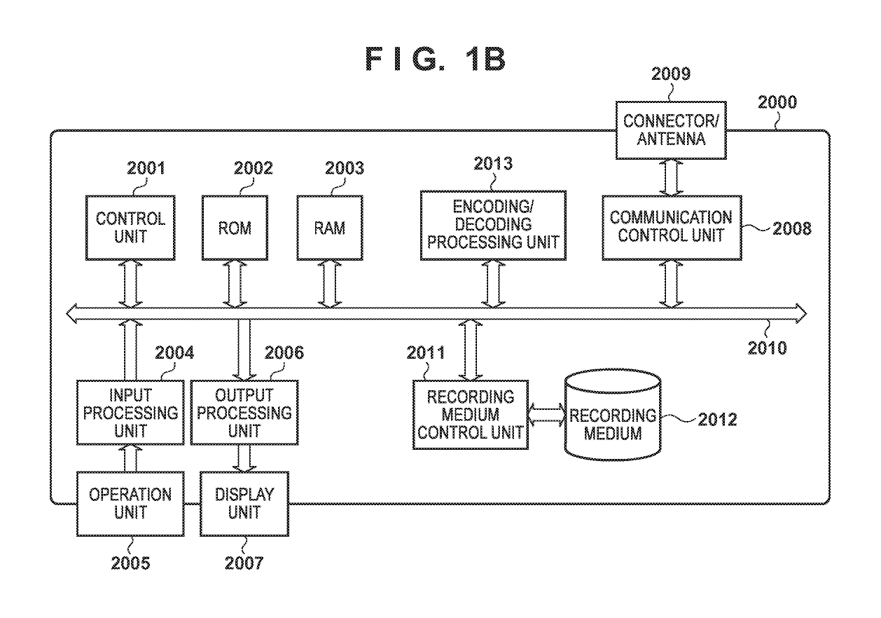

FIG. 1A is a block diagram showing an example of the functional arrangement of the digital camera 1000 as an example of the video supply apparatus according to this embodiment. FIG. 1B is a block diagram showing an example of the functional arrangement of a mobile phone 2000 as an example of the video obtaining apparatus according to this embodiment. Note that one or more functional blocks shown in FIGS. 1A and 1B can be implemented by hardware such as ASIC or programmable logic array (PLA) or by causing a programmable processor such as a CPU or MPU to execute software. The functional blocks may be implemented by combining software and hardware. Hence, in the following explanation, even when different functional blocks are described as the operation entity, the same hardware can be implemented as the entity.

Examples of the arrangements of the digital camera 1000 and the mobile phone 2000 to which the embodiment is applicable will be described with reference to FIGS. 1A and 1B.

In the digital camera 1000 shown in FIG. 1A, functional blocks to be described below can be connected to an internal bus 1010 and send/receive data to/from each other.

A control unit 1001 is a programmable processor such as a CPU or MPU and controls the entire digital camera 1000 by sending a control instruction to each unit in accordance with a user operation. The control unit 1001 executes various kinds of control programs stored in a ROM (Read Only Memory) 1002, for example, a program configured to control a communication control unit 1008 according to this embodiment.

The ROM 1002 is a nonvolatile storage medium such as a flash memory. A RAM (Random Access Memory) 1003 is formed from a DRAM or the like and used as a work memory that appropriately stores programs, variables, and temporary data for works needed by the control unit 1001 at the time of operation.

An imaging optical system 1013 is a photographing lens constructed as a module including a focus, stop, zoom mechanism, and processor for controlling them (none are shown), and forms an optical image of an object. The control unit 1001 can obtain and control the states of the focus, stop, and zoom of the imaging optical system 1013 via the internal bus 1010.

An image sensor 1014 is formed from a CCD or CMOS element. An optical signal received by the image sensor is photoelectrically converted into an electrical signal. After that, the analog electrical signal is converted into a digital signal by an internal A/D converter.

A camera signal processing unit 1015 performs various kinds of correction processing, for example, color conversion and resize processing such as predetermined pixel interpolation or reduction for the digital signal converted by the image sensor 1014 under the control of the control unit 1001.

An encoding/decoding processing unit 1016 compression-encodes the digital signal processed by the camera signal processing unit 1015 under the control of the control unit 1001 into a predetermined bit rate and format, and also decodes compression-encoded video data recorded in a recording medium 1012. Note that not only a video but also an audio is obtained and recorded in fact, although a description thereof will be omitted because it is not directly relevant to the present invention. When a microphone and a speaker (neither are shown) are used, an audio signal can equally be handled by the arrangement of the functional blocks for the video. In addition, when an audio is simultaneously recorded together with a video, and the video and the audio are multiplexed by the encoding/decoding processing unit 1016, video data with audio can be generated.

An input processing unit 1004 accepts a user operation on an operation unit 1005, generates a controls signal according to the operation, and supplies it to the control unit 1001. For example, the operation unit 1005 includes a character information input device such as a keyboard and a pointing device such as a mouse or touch panel as input devices that accept a user operation. The touch panel is, for example, an input device configured to output coordinate information corresponding to a position of contact on an input unit formed into a plane. The operation unit 1005 also includes a remote-controllable device for receiving a signal such as an infrared remote controller. The user can cause the digital camera 1000 to perform an operation according to a user operation via the input devices. Note that the following description will be made assuming that the input device is a touch panel in this embodiment.

An output processing unit 1006 outputs a display signal to make a display unit 1007 perform display based on display data of a GUI (Graphical User Interface) generated by the control unit 1001 in accordance with a program. Note that when a touch panel is used as the operation unit 1005, the operation unit 1005 and the display unit 1007 can be integrated. For example, the touch panel is formed such that the display on the display unit 1007 is not impeded by the light transmittance, and attached to the upper layer of the display surface of the display unit 1007. When input coordinates on the touch panel and display coordinates on the display unit 1007 are associated with each other, a GUI can be formed as if the user could directly operate the screen displayed on the display unit 1007. For example, upon detecting a contact on coordinates corresponding to a button-shaped GUI that the operation unit 1005 causes the display unit 1007 to display, the control unit 1001 regards that the button is pressed and executes processing corresponding to the button. This can implement the same function as in a case where a physical key is pressed.

A recording medium control unit 1011 is connected to the recording medium 1012 which may be an HDD or a nonvolatile semiconductor memory, and reads out data from the connected recording medium 1012 or writes data in the recording medium 1012 under the control of the control unit 1001. Note that the recording medium 1012 to which the recording medium control unit 1011 can be connected via a socket (not shown) or the like may be a detachable nonvolatile semiconductor memory, for example, a memory card. The recording medium 1012 can store information necessary for the control of the control unit 1001 as well as shot video data.

The communication control unit 1008 communicates with the mobile phone 2000 via a connector (wired)/antenna (wireless) 1009 under the control of the control unit 1001. For example, the communication control unit 1008 can perform communication complying with a communication standard such as IEEE802.11 or Bluetooth® for wireless communication or IEEE802.3 for wired communication.

In the mobile phone 2000 shown in FIG. 1B, many parts are the same as in the digital camera 1000. A control unit 2001 to an encoding/decoding processing unit 2013 are the same as in the digital camera 1000, and a repetitive description thereof will be omitted. The mobile phone 2000 is a device including a smartphone and a tablet PC.

(Outline of Processing Concerning Live Streaming Using Playlist)

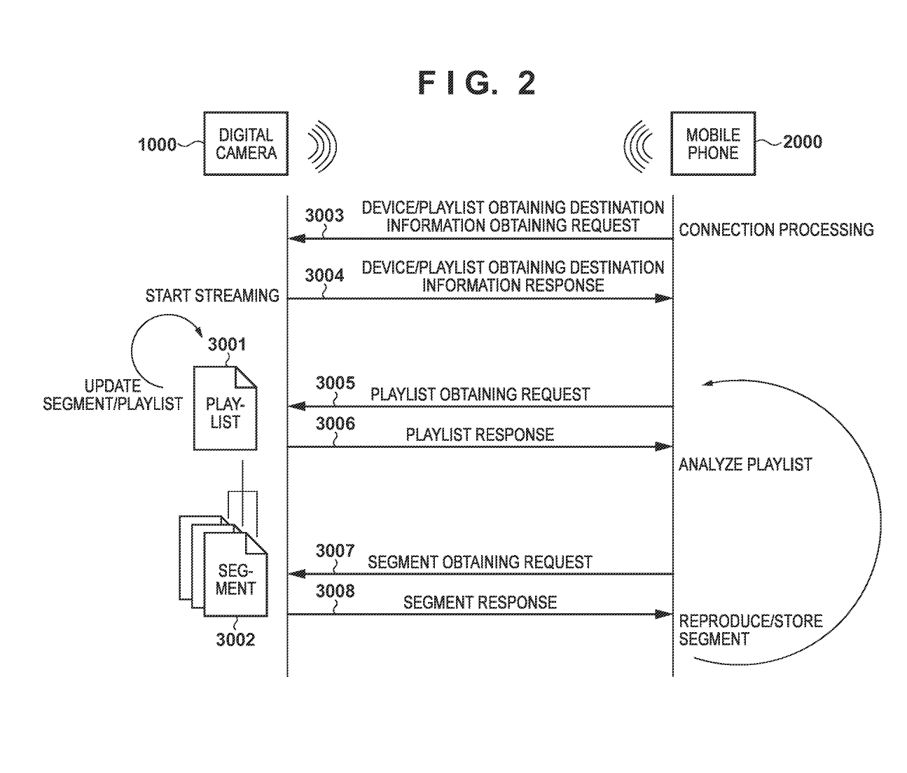

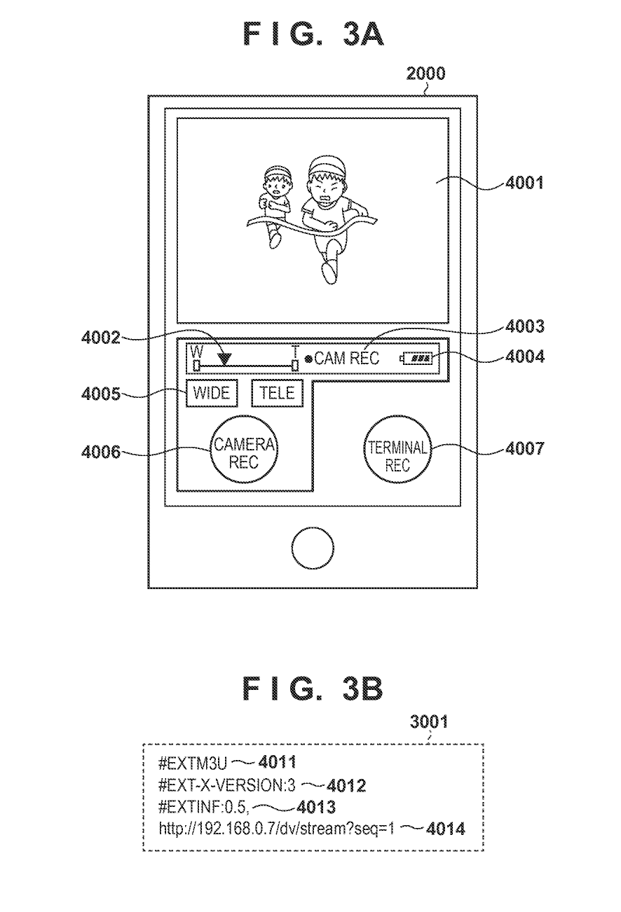

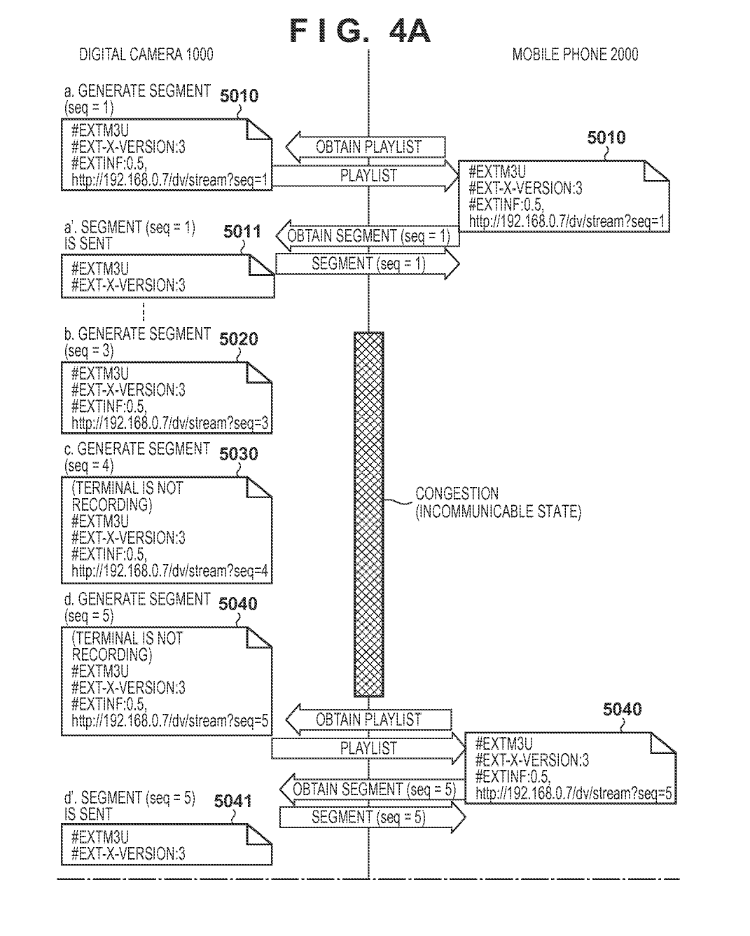

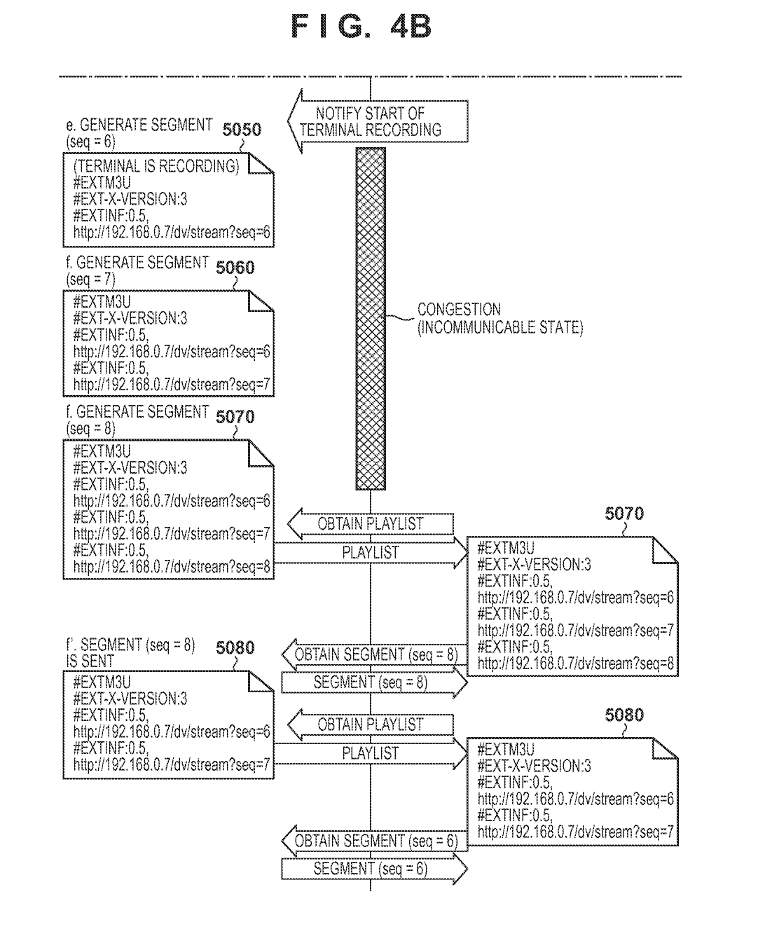

The outline of processing of live streaming using a playlist according to this embodiment will be described next with reference to FIGS. 2 and 3. Processing in a case where communication cannot periodically be performed due to congestion or the like will be described with reference to FIGS. 4A and 4B.

When the user instructs, from the operation unit 1005, the digital camera 1000 to transit to a mode to perform live streaming, the control unit 1001 sets the communication control unit 1008 in a communicable state.

The control unit 2001 of the mobile phone 2000 activates applications necessary for communication connection processing and live streaming in accordance with an operation instruction to the operation unit 2005 by the user. The control unit 2001 reads out a program stored in the ROM 2002 or the recording medium 2012 and controls the communication control unit 2008 to start connection processing to the digital camera 1000.

Here, the digital camera 1000 and the mobile phone 2000 perform communication complying with, for example, HTTP (HyperText Transfer Protocol) and UPnP (Universal Plug and Play) used for device connection. When a device is connected to the network, the UPnP-capable mobile phone 2000 sets an IP address by DHCP (Dynamic Host Configuration Protocol) or AutoIP.

To enable devices on the network to recognize each other, according to the procedure of “device discovery and control”, the mobile phone 2000 that has obtained the IP address sends an information obtaining request 3003 to search for a device and obtain the type and service function of a response device.

In response to the information obtaining request 3003 sent from the mobile phone 2000, the digital camera 1000 sends a response 3004 including device information and playlist obtaining destination information that is information unique to the device. Upon obtaining the information of the service function, the mobile phone 2000 can specify the digital camera 1000 that provides live streaming and perform connection processing and can also obtain the playlist obtaining destination information.

When the connection processing between the digital camera 1000 and the mobile phone 2000 is completed, the digital camera 1000 starts live streaming. FIG. 3A shows an example of an application screen when live streaming is performed using the mobile phone 2000 in which the operation unit 2005 and the display unit 2007 are integrated. Live streaming data sent from the digital camera 1000 is displayed in a display region 4001 of the display unit 2007 and periodically updated. In the example of FIG. 3A, the status of the digital camera 1000 including zoom position information 4002, a recording state 4003, battery information 4004, and the like is displayed, and various kinds of operations of the digital camera 1000 or the mobile phone 2000 can be performed. More specifically, buttons 4005, 4006, and 4007 used to perform a zoom operation, a recording start/stop instruction to the digital camera 1000, and a recording start/stop instruction to the mobile phone 2000 are arranged. If the user presses the button 4007 to start recording in the mobile phone 2000, the received live streaming data is displayed in the display region 4001 and also recorded in the recording medium 2012 of the mobile phone 2000. When the mobile phone 2000 is recording the live streaming data, the usage pattern is recording. On the other hand, when the mobile phone 2000 is not recording the live streaming data (that is, only viewing), the usage pattern is viewing. Note that information representing the usage pattern is sent from the mobile phone 2000 to the digital camera 1000 not only at the start of live streaming and at the start/end of recording in the mobile phone 2000 but also periodically (pattern sending), as will be described later. Hence, the digital camera 1000 can grasp the usage pattern in the mobile phone 2000.

The control unit 1001 of the digital camera 1000 causes the image sensor 1014 to start signal output, and causes the camera signal processing unit 1015 to process the signal output to appropriate video data by various kinds of interpolation processing and send the data to the encoding/decoding processing unit 1016. The encoding/decoding processing unit 1016 compression-encodes the received video data into a predetermined bit rate and format, and stores the data in the RAM 1003 or the recording medium 1012 as a segment 3002 divided by a predetermined time length Ts. Note that in this embodiment, a description will be made assuming that Ts is 0.5 sec.

The control unit 1001 generates information (obtaining information: representing, for example, a path representing a segment storage location) representing the obtaining destination from which the mobile phone 2000 obtains the segment (obtaining information generation). The control unit 1001 generates a playlist 3001 including the generated obtaining information, as will be described later with reference to FIG. 3B.

The playlist 3001 according to this embodiment will be described here in more detail with reference to FIG. 3B. The playlist 3001 is defined by, for example, the Extended M3U format. An identifier tag 4011 is a tag to identify the description format of the playlist, and describes “EXTM3U” here. A version tag 4012 represents the version of the protocol describing the playlist and in this embodiment, describes, for example, a numerical value “3” as the version.

A time length tag 4013 and an obtaining information tag 4014 are tags concerning the information of the segment. The time length tag 4013 describes a tag representing the time length of the segment 3002 and the time (sec) by an integer or a decimal fraction. In this embodiment, since the time length of the segment is set to Ts=0.5 (sec), the value set in the time length tag 4013 is “0.5”. The obtaining information tag 4014 describes the obtaining information of the segment 3002, that is, the path of the obtaining destination and a parameter (query parameter) to be sent to the obtaining destination as needed. In this embodiment, the pieces of information described in the time length tag 4013 and the obtaining information tag 4014, which define the segment, will be referred to as segment information altogether. These pieces of information may continuously be described.

As the time length Ts of the segment 3002, one of a value set in the mobile phone 2000 in advance, the time length tag 4013 included in the segment information of the playlist, and a value included in the device information of the digital camera 1000 can be set in the mobile phone 2000.

Referring back to FIG. 2, the mobile phone 2000 sends a playlist obtaining request 3005 to the playlist obtaining destination obtained by the response 3004 Ts (sec) after the start of live streaming. The playlist obtaining request 3005 is sent using, for example, the HTTP GET method.

The digital camera 1000 sends a playlist response 3006 in response to the playlist obtaining request 3005 (also called message sending or list sending), thereby provides the playlist 3001 in which one piece of segment information (that is, including the time length and the obtaining information) is described.

The mobile phone 2000 receives the playlist response 3006 sent from the digital camera 1000 (also called message reception or list reception), and analyzes the playlist 3001 included in the received playlist response 3006. The mobile phone 2000 sends a segment obtaining request 3007 to obtain a segment in accordance with the obtaining information described in the segment obtaining information tag 4014 in the playlist 3001.

The digital camera 1000 sends a response 3008, thereby sending the requested segment 3002 to the mobile phone 2000 (also called data sending or segment sending).

Upon receiving the segments 3002 (also called data reception or segment reception), the mobile phone 2000 sequentially connects segments in the chronological order, causes the encoding/decoding processing unit 2013 to decode them, and causes the display unit 2007 to do reproduction and display via the output processing unit 2006. If the user presses the button 4007 of the live streaming application to execute recording in the mobile phone 2000, the decoded data (or a data portion obtained by removing a header and the like from the segment 3002) is recorded in the recording medium 2012.

During execution of live streaming processing, the digital camera 1000 generates a new segment and generates or updates the playlist at an interval of Ts (sec), and deletes, from the playlist, the segment information of the segment sent to the mobile phone 2000. The digital camera 1000 also deletes, from the RAM 1003 or the recording medium 1012, the segment sent to the mobile phone 2000. The mobile phone 2000 sends the playlist obtaining request 3005 at the interval of Ts (sec) and, based on the segment information described in the playlist 3001, sends the obtaining request of the segment.

Note that an ID unique to the mobile phone 2000 or the live streaming application is added to the requests 3005 and 3007 to be sent from the mobile phone 2000. The digital camera 1000 sends the requested segment only in response to a request with the same ID as the ID added to the obtaining request received for the first time. That is, the digital camera 1000 and the mobile phone 2000 perform streaming only in one-to-one connection.

If the communication condition is good, the series of processes from the playlist obtaining request 3005 to the response 3008 to the segment obtaining request 3007 is periodically performed without any delay. However, in a state (congestion) in which, for example, communication cannot be performed because user accesses concentrate to a specific destination on the communication lines, it may be impossible to do communication as described above. FIGS. 4A and 4B shows an example of the description of playlists according to the embodiment considering the congestion state.

In this embodiment, the digital camera 1000 controls the description contents of a playlist in accordance with the usage pattern of segments in the mobile phone 2000.

A case where the segment usage pattern in the mobile phone 2000 is not recording (that is, only viewing) will be described first. The digital camera 1000 describes the obtaining information of the first (seq=1) segment in the playlist, and sends a described playlist 5010 to the mobile phone 2000. The mobile phone 2000 sends the obtaining request for the segment (seq=1) based on the obtaining information of the designated segment and obtains the segment (seq=1). Since the segment (seq=1) could be sent, the digital camera 1000 updates the playlist to a playlist 5011 in which the segment information about the segment (seq=1) is deleted. After that, the digital camera 1000 generates or updates a segment for each predetermined time length Ts. At this time, the digital camera 1000 generates a playlist that describes only the segment information of a segment generated latest at the time of playlist updating, or updates the playlist so as to include only the segment generated latest (5020 to 5041). Segments other than the segment generated latest as described above are deleted from the RAM 1003 or the recording medium 1012. If the congestion resolves, and the playlist obtaining request 3005 is received from the mobile phone 2000 again, the digital camera 1000 provides the updated playlist 5040 (seq=5) and causes the mobile phone 2000 to obtain the segment generated latest. The digital camera 1000 can thus prevent a number of segment information accumulated due to the influence of congestion from being described in the playlist and increasing the information amount of the playlist. At the same time, it is possible to prevent the usage of the memory for recording the segments from increasing. In other words, if the segment usage pattern in the mobile phone 2000 prioritizes minimizing delay rather than minimizing segment loss, the band or memory usage can be prevented from being wasted by an increase in the information amount of the playlist. Since the mobile phone 2000 can obtain and reproduce the segment generated latest regardless of the influence of congestion, no delay occurs due to accumulation of unobtained segments. That is, even if a segment occurs for which no obtaining request is sent within the predetermined time length, the segment is replaced with the latest segment, and the mobile phone 2000 can therefore obtain and reproduce the latest segment.

On the other hand, if congestion occurs in a case where the usage pattern in the mobile phone 2000 is recording, both the segment information of a segment generated latest (seq=8) and the segment information of unsent segments (seq=6, 7) are described in the playlist (5050 to 5070). The mobile phone 2000 sends the playlist obtaining request 3005, obtains the playlist 5070, and preferentially obtains the segment generated latest (seq=8). The mobile phone 2000 further obtains a playlist 5080 updated after the segment (seq=8) is obtained, and obtains the unobtained segment (seq=6 or 7). Note that the unobtained segments may continuously be obtained within the time Ts (sec), or segments that still remain unobtained even after such processing may be obtained after the end of viewing. This makes it possible to obtain the latest segment and reproduce streaming with little delay, and also obtain segments delayed in obtaining due to congestion and record data without loss. That is, if the segment usage pattern prioritizes minimizing loss rather than minimizing segment delay, a playlist including unobtained segments is generated, thereby enabling streaming to prevent segment loss.

(Series of Operations of Digital Camera 1000)

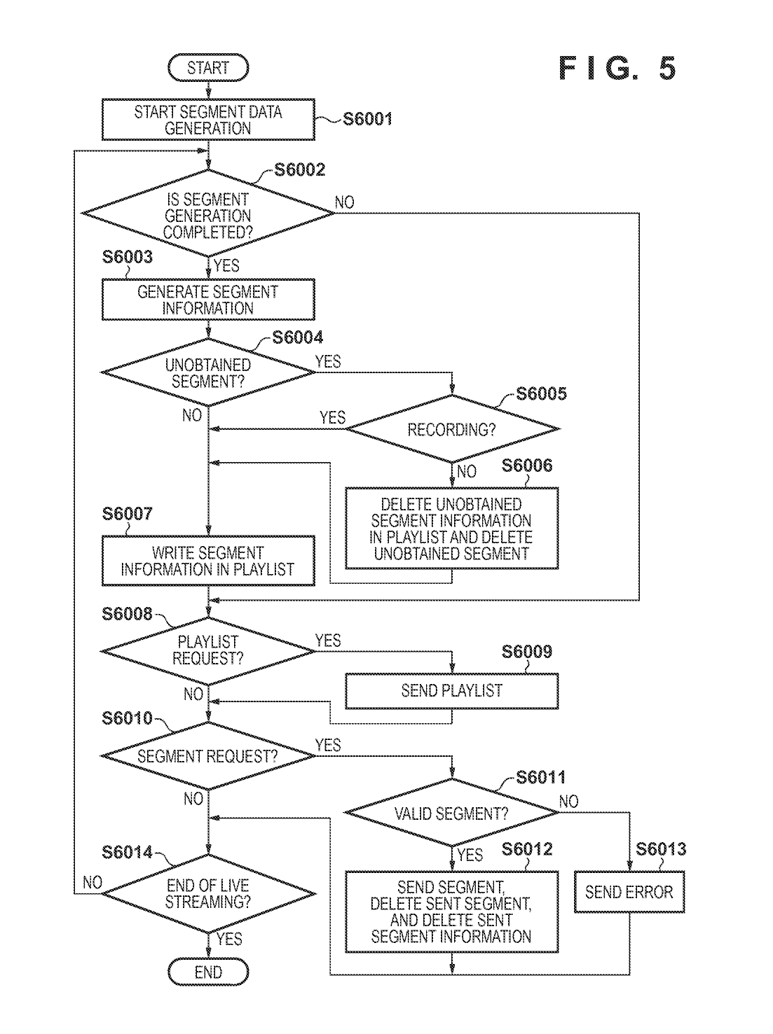

A series of operations of processing in live streaming of the digital camera 1000 will be described next with reference to FIG. 5.

Note that this processing starts when connection between the digital camera 1000 and the mobile phone 2000 is established by a connection request from the mobile phone 2000 as the streaming destination in a state in which the digital camera 1000 is connected to the communication network, and live streaming is possible. This processing is implemented by causing the control unit 1001 to extract the program stored in the ROM 1002 to the working area of the RAM 1003 and execute.

In step S6001, the control unit 1001 starts segment data generation (also called segment generation) according to the start of live streaming. The control unit 1001 causes the image sensor 1014 to start signal output, and causes the camera signal processing unit 1015 to process the output to appropriate video data by various kinds of interpolation processing and send the data to the encoding/decoding processing unit 1016. The encoding/decoding processing unit 1016 compression-encodes the received video data into a predetermined bit rate and format, and starts processing of dividing the data by the predetermined time length Ts (in this embodiment, 0.5 sec).

In step S6002, the control unit 1001 determines whether data generation of one segment is completed. The control unit 1001 confirms whether data divided into segments (length of 0.5 sec) is stored in the RAM 1003 or the recording medium 1012. Upon determining that the data generation is completed, the process advances to step S6003. Upon determining that the data generation is not completed, the process advances to step S6008. Note that the control unit 1001 confirms completion of segment generation by a method of periodically querying (polling) the RAM 1003 or the like. Completion of segment data generation may be confirmed by, for example, an interrupt to notify completion of segment data write.

In step S6003, the control unit 1001 generates segment information that describes the time length and obtaining information of the generated segment. The obtaining information can be information representing, for example, the storage location address or file name of the segment, and can include a query parameter, as described above. The time length of the segment is 0.5 sec, as described above. The control unit 1001 stores the generated segment information in the RAM 1003. If no playlist is generated yet, the control unit 1001 newly generates a playlist.

In step S6004, the control unit 1001 determines whether at least one unobtained segment exists. The control unit 1001 determines whether an unobtained segment exists by determining whether at least one piece of segment information described in the playlist exists. Upon determining that at least one piece of segment information exists (5020 in the example of FIG. 4A), the process advances to step S6005. Upon determining that no segment information exists (playlist 5011), the process advances to step S6007.

In step S6005, the control unit 1001 determines, based on the segment usage pattern sent from the mobile phone 2000, whether the mobile phone 2000 is recording the segments. Information representing the segment usage pattern is periodically sent from the control unit 2001 (pattern sending unit) of the mobile phone 2000 via the connector/antenna 2009 in parallel to this processing, and the control unit 1001 records the received information in the RAM 1003. The control unit 1001 reads out the information representing the segment usage pattern, which is recorded in the RAM 1003, and determines the segment usage pattern. Upon determining that the usage pattern in the mobile phone 2000 is the usage pattern including recording of segments, the control unit 1001 advances the process to step S6007. Upon determining that the usage pattern does not include recording (for example, includes only viewing), the process advances to step S6006.

In step S6006, the control unit 1001 deletes unobtained segment information described in the playlist from the description of the playlist and the unobtained segments stored in the RAM 1003 or the recording medium 1012, and advances the process to step S6007.

In step S6007, the control unit 1001 reads out the segment information generated in step S6003 from the RAM 1003 and writes it in the playlist. If the playlist includes an unobtained segment, and the mobile phone 2000 is recording the segments, the segment information is additionally described in the playlist, as described above with reference to FIGS. 4A and 4B. On the other hand, if the mobile phone 2000 is not recording the segments, only the latest segment information (that is, only one piece of segment information) is described in the playlist.

In step S6008, the control unit 1001 determines the presence/absence of the playlist obtaining request 3005 from the mobile phone 2000. Upon determining based on a notification from the communication control unit 1008 that the playlist obtaining request from the mobile phone 2000 exists, the control unit 1001 advances the process to step S6009. Upon determining that the playlist obtaining request does not exist, the control unit 1001 advances the process to step S6010.

In step S6009, the control unit 1001 sends the playlist response 3006 in response to the playlist obtaining request 3005 and provides the playlist described in step S6007 to the mobile phone 2000.

In step S6010, the control unit 1001 determines the presence/absence of the segment obtaining request 3007 from the mobile phone 2000. Upon determining based on a notification from the communication control unit 1008 that the segment obtaining request exists, the control unit 1001 advances the process to step S6011. Upon determining that the segment obtaining request has been absent for a predetermined time, the control unit 1001 advances the process to step S6014.

In step S6011, the control unit 1001 determines whether the segment requested in step S6010 is valid. The control unit 1001 determines the validity depending on whether the ID of the requested segment corresponds to the segment written in step S6002. If the requested segment exists, the control unit 1001 determines that the requested segment is valid, and advances the process to step S6012. If the requested segment does not exist because of deletion or the like, the control unit 1001 determines that the requested segment is invalid, and advances the process to step S6013.

In step S6012, the control unit 1001 sends the data of the corresponding segment as the response 3008 to the segment obtaining request 3007. In addition, the control unit 1001 deletes the sent segment from the RAM 1003 or the recording medium 1012 that stored it, and also deletes the corresponding segment information from the description of the playlist and the RAM 1003. When the deletion processing is completed, the control unit 1001 advances the process to step S6014. Note that in this embodiment, since the segment is sent using TCP, reach of the sent segment is guaranteed. Hence, the control unit 1001 deletes the sent segment from the playlist, thereby managing remaining segments as unsent segments.

In step S6013, the control unit 1001 sends an error status as the response 3008 to the segment obtaining request 3007, and advances the process to step S6014.

In step S6014, the control unit 1001 determines whether to end live streaming. If a stop instruction is received from the mobile phone 2000 by communication different from that of the processing, or a segment sending stop instruction is received from the user via the operation unit 1005, the series of operations of this processing ends. On the other hand, upon determining that the above-described stop instruction is not received, the process returns to step S6002 to process a new segment.

Note that in this embodiment, the presence/absence of an unobtained segment is determined based on the segment information described in the playlist. However, it may be determined whether there exist one or more pieces of unobtained segment information or one or more unobtained segments stored in the RAM 1003 or the recording medium 1012.

(Series of Operations of Mobile Phone 2000)

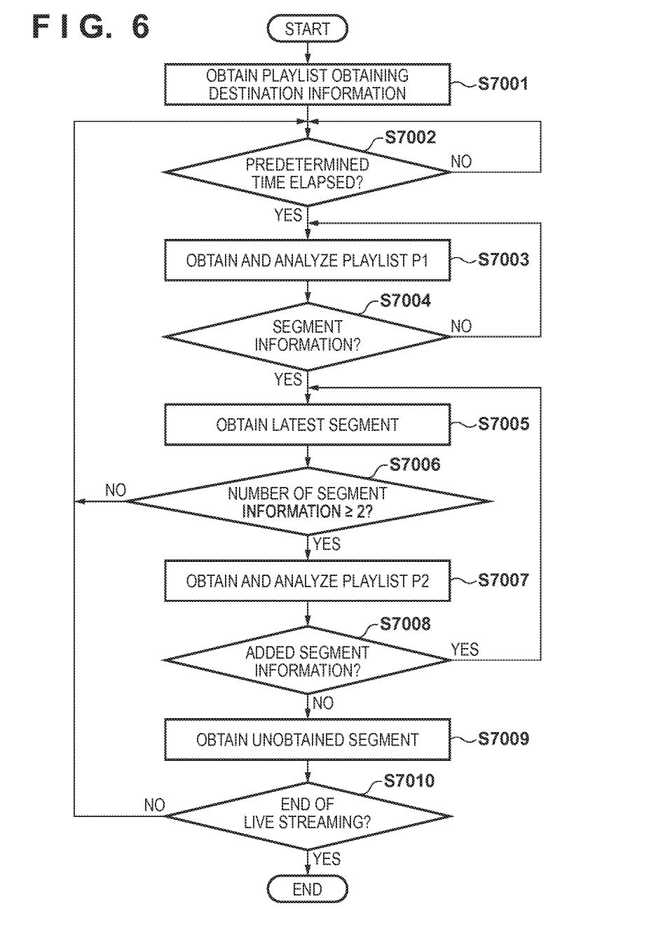

A series of operations of the mobile phone 2000 concerning live streaming will be described next with reference to FIG. 6.

Note that this processing starts upon receiving the response 3004 of the digital camera 1000 to the information obtaining request 3003 after the application of the mobile phone 2000 is activated, and connection between the mobile phone 2000 and the digital camera 1000 is established. This processing is implemented by causing the control unit 2001 to extract the program stored in the ROM 2002 to the working area of the RAM 2003 and execute.

At this time, the control unit 2001 records the viewing state in the set value in the RAM 2003 at the reception timing of the response 3004, and also sets information representing the usage pattern of segments to viewing and sends it to the digital camera 1000 via the connector/antenna 2009. From then on, the control unit 2001 confirms the set value in the RAM 2003 and sends the information representing the usage pattern to the digital camera 1000 at a predetermined time interval (experimentally defined interval that produces no communication load).

In step S7001, the control unit 2001 obtains playlist obtaining destination information included in the response 3004 from the digital camera 1000 and stores it in the RAM 2003.

In step S7002, the control unit 2001 determines whether a predetermined time has elapsed. The predetermined time can be set to the same value as the predetermined time length Ts generated by the digital camera 1000. Upon determining that the predetermined time has elapsed, the control unit 2001 advances the process to step S7003. Upon determining that the predetermined time has not elapsed, the control unit 2001 returns the process to step S7002 to wait for the elapse of the predetermined time.

In step S7003, the control unit 2001 obtains a playlist P1 and analyzes the obtained playlist P1. The control unit 2001 first reads out the playlist obtaining destination information obtained in step S7001 from the RAM 2003, sends the playlist obtaining request 3005, and obtains the playlist from the digital camera 1000. Next, the control unit 2001 analyzes the obtained playlist and refers to segment information. More specifically, the control unit 2001 confirms the playlist format by the identifier tag 4011 shown in FIG. 3B and the version by the version tag 4012, and refers to the segment information, that is, the time length set in the time length tag 4013 and the obtaining information described in the obtaining information tag 4014.

In step S7004, the control unit 2001 determines whether segment information exists in the playlist obtained in step S7003. If segment information is described in the playlist, the control unit 2001 determines that the segment information exists, and advances the process to step S7005. Upon determining that the segment information does not exist, the control unit 2001 returns the process to step S7003 to obtain the playlist again.

In step S7005, the control unit 2001 obtains the latest segment from the digital camera. If one piece of segment information is described in the playlist obtained in step S7003, the segment information is decided as the obtaining target. If one piece of segment information exists, as described above, the segment is the latest segment. On the other hand, a plurality of pieces of segment information are described, in this embodiment, the latest segment out of the segments described in the playlist is decided as the most prioritized obtaining target to do live reproduction with little delay. Hence, the control unit 2001 sends the segment obtaining request 3007 for the obtaining information described in the latest segment information, and obtains the latest segment from the digital camera 1000. The control unit 2001 stores the obtained segment in the RAM 2003 or the recording medium 2012, and then transfers the segment to the encoding/decoding processing unit 2013 to perform decoding. In addition, the control unit 2001 displays the segment on the display unit 2007 via the output processing unit 2006, thereby performing reproduction and display. If recording is being executed in the mobile phone 2000 by pressing the button 4007 of the application shown in FIG. 3A, the received segments 3002 are sequentially connected, decoded by the encoding/decoding processing unit 2013, and recorded in the recording medium 2012. When the button 4007 is pressed on the application, the control unit 2001 sets the recording state in the set value in the RAM 2003, and immediately sets the information representing the usage pattern of segments to recording and sends it to the digital camera 1000. If the button 4007 is pressed on the application to stop the recording, the control unit 2001 changes the set value in the RAM 2003 to the viewing state again, and sets the information representing the usage pattern of segments to viewing and sends it to the digital camera 1000.

In step S7006, the control unit 2001 determines whether two or more pieces of segment information are described in the playlist obtained in step S7003. A plurality of pieces of segment information are described in step S7005, the process advances to step S7007. If one piece of segment information is described, the process returns to step S7002. For the sake of convenience, let Sn be the number of segment information described in the processing target playlist.

In step S7007, the control unit 2001 sends the playlist obtaining request 3005 again, as in step S7003, to obtain an unobtained segment, obtains a playlist P2 from the digital camera 1000, and obtains segment information.

In step S7008, the control unit 2001 determines whether the playlist obtained in step S7007 includes newly added segment information. If the number of information is larger than Sn−1, a new segment is generated after playlist obtaining in step S7003. Hence, the process returns to step S7005 to obtain the latest segment. If the number of segment information is Sn−1, an unobtained old segment exists. Hence, the process advances to step S7009 to obtain the segment.

In step S7009, the control unit 2001 sends the segment obtaining request 3007 by referring to the obtaining information described in the segment information corresponding to the unobtained segment, and obtains the unobtained segment from the digital camera 1000. The control unit 2001 records the obtained segment in the RAM 2003 or the recording medium 2012. If there exist two or more unobtained segments, a plurality of segment obtaining requests 3007 are sent within the predetermined time of step S7002 to obtain the unobtained segments. However, the control unit 2001 may receive an interrupt notification at the interval of the predetermined time of step S7002. Upon receiving the interrupt notification, the control unit 2001 may temporarily stop obtaining of the unobtained segments and advance the process to step S7010. If an unobtained segment still remains even after the end of live streaming, the processing of obtaining unobtained segments may be continued to obtain all the segments. The segments obtained in this step are older than the segment obtained in step S7005 in terms of generation timing, and are therefore recorded in the recording medium 2012 without being used for reproduction. At this time, when the received segments are connected in the chronological order, data reconstruction with little break (that is, recording of streaming data with little loss) is possible. Note that if an unobtained segment that cannot be obtained within the above-described predetermined time exists, the control unit 2001 connects segments in a section where the segments are sequentially obtained, and data loss is not present, and records the data in the recording medium 2012. When the unobtained segments are obtained, the control unit 2001 advances the process to step S7010.

In step S7010, the control unit 2001 determines whether to end live streaming. Upon determining that an operation of stopping segment obtaining has been done, for example, if an instruction to stop live streaming is received from the user via the operation unit 2005, or the digital camera 1000 is disconnected, the control unit 2001 ends the series of operations of this processing. On the other hand, without any operation of stopping segment obtaining, the process returns to step S7002 to continue segment obtaining.

As described above, in this embodiment, segment information to be described in a playlist is limited to latest segment information in accordance with the segment usage pattern in the mobile phone 2000. If the mobile phone 2000 need not record all segments, the efficiency of the amount of information sent from the digital camera 1000 can be improved in accordance with the usage pattern in the mobile phone 2000 at the time of streaming. That is, since the information amount of the playlist can be prevented from being increased by segment information that accumulate in case of congestion, the efficiency of the information amount of the playlist sent from the digital camera 1000 can be improved. This effect is conspicuous when the playlist is sent and updated at a very short interval. Additionally, in the digital camera 1000 that sends the segments, the usage of the memory for storing the segments can be prevented from increasing. Furthermore, since the mobile phone 2000 can preferentially obtain the latest segment, reproduction with little delay is possible in streaming. Since the information of segments is simplified, the load of segment selection in the mobile phone 2000 is unnecessary, and by extension, smoother live viewing is possible.

The description of the playlist is changed in accordance with the segment usage pattern in the mobile phone 2000. When recording segments, unobtained segment information is described in the playlist and provided to the mobile phone 2000. This allows the mobile phone 2000 to obtain unobtained segments after the latest segment is obtained and record the segments while preventing data loss.

In this embodiment, when recording segments, the mobile phone 2000 prioritizes obtaining the latest segment out of the received playlist, and then obtains unobtained segments. This allows the mobile phone 2000 to implement reproduction with little delay in live viewing while recording the segments.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-104508, filed May 20, 2014 which is hereby incorporated by references herein in its entirety.

What is claimed is:

1. A video supply apparatus for streaming video data to an external apparatus, comprising:
a segment generation unit configured to generate a segment representing a part of a predetermined time length of the video data;
an obtaining information generation unit configured to generate obtaining information used by the external apparatus to obtain the segment;
a list sending unit configured to send a list including the obtaining information to the external apparatus; and
a segment sending unit configured to send, to the external apparatus, the segment requested by the external apparatus using the obtaining information,
the apparatus further comprising an obtaining unit configured to obtain information representing a usage type of the video data from the external apparatus,
wherein if the information representing the usage type of the video data represents a first type, the list sending unit sends the list that includes the obtaining information about a latest segment but does not include the obtaining information about another segment unsent to the external apparatus, and
if the information representing the usage type of the video data represents a second type, the list sending unit sends the list that includes the obtaining information about the latest segment and the obtaining information about the other segment unsent to the external apparatus.

2. The apparatus according to claim 1, wherein the first type is a usage type that prioritizes minimizing delay rather than minimizing loss of the video data, and the second type is a usage type that prioritizes minimizing loss rather than minimizing delay of the video data.

3. The apparatus according to claim 1, wherein the first type is a usage type that does not record the video data based on the segment received by the external apparatus, and the second type is a usage type that records the video data based on the segment received by the external apparatus.

4. The apparatus according to claim 1, wherein if the information representing the usage type of the video data represents the first type, the list sending unit updates the list so as to include the obtaining information about the latest segment and not to include the obtaining information about the other segment unsent to the external apparatus every time the segment is generated.

5. The apparatus according to claim 1, wherein if the information representing the usage type of the video data represents the second type, the list sending unit updates the list by adding the obtaining information about the latest segment to the list every time the segment is generated.

6. The apparatus according to claim 1, wherein the list sending unit updates the list by deleting, from the list, the obtaining information about the segment sent to the external apparatus.

7. The apparatus according to claim 1, further comprising a capturing unit,
wherein the segment generation unit generates the video data of the part of the predetermined time length from a video captured by the capturing unit.

8. A video obtaining apparatus comprising:
a list receiving unit configured to receive, from a video supply apparatus for streaming video data, a list including obtaining information used to obtain a segment representing a part of a predetermined time length of the video data;
a request unit configured to request the segment from the video supply apparatus using the obtaining information;
a segment receiving unit configured to receive the requested segment,
the apparatus further comprising a type sending unit configured to send information representing a usage type of the video data to the video supply apparatus,
wherein the information representing the usage type of the video data includes one of a first type that prioritizes minimizing delay rather than minimizing loss of the video data and a second type that prioritizes minimizing loss rather than minimizing delay of the video data.

9. The apparatus according to claim 8, wherein the first type is a usage type that does not record the video data, and the second type is a usage type that records the video data.

10. The apparatus according to claim 8, further comprising a display unit configured to receive the requested segment and display a latest segment out of the received segments but not to display another segment.

11. A video supply system in which the video supply apparatus according to claim 1 and a video obtaining apparatus are communicable connected to each other,
the video obtaining apparatus comprising:
a list receiving unit configured to receive, from a video supply apparatus for streaming video data, a list including obtaining information used to obtain a segment representing a part of a predetermined time length of the video data;
a request unit configured to request the segment from the video supply apparatus using the obtaining information;
a segment receiving unit configured to receive the requested segment,
the apparatus further comprising a type sending unit configured to send information representing a usage type of the video data to the video supply apparatus,
wherein the information representing the usage type of the video data includes one of a first type that prioritizes minimizing delay rather than minimizing loss of the video data and a second type that prioritizes minimizing loss rather than minimizing delay of the video data.

12. A control method of a video supply apparatus for streaming video data to an external apparatus, comprising:
a segment generation step of generating a segment representing a part of a predetermined time length of the video data by a segment generation unit;
an obtaining information generation step of generating obtaining information used by the external apparatus to obtain the segment;
a list sending step of sending a list including the obtaining information to the external apparatus by a list sending unit; and
a segment sending step of sending, to the external apparatus, the segment requested by the external apparatus using the obtaining information,
the method further comprising an obtaining step of obtaining information representing a usage type of the video data from the external apparatus of a streaming destination,
wherein in the list sending step,
if the information representing the usage type of the video data represents a first type, the list that includes the obtaining information about a latest segment but does not include the obtaining information about another segment unsent to the external apparatus is sent to the external apparatus, and
if the information representing the usage type of the video data represents a second type, the list that includes the obtaining information about the latest segment and the obtaining information about the other segment unsent to the external apparatus is sent to the external apparatus.

13. A control method of a video obtaining apparatus, comprising:
a list receiving step of receiving, from a video supply apparatus for streaming video data, a list including obtaining information used to obtain a segment representing a part of a predetermined time length of the video data;
a request step of requesting the segment from the video supply apparatus using the obtaining information;
a segment receiving step of receiving the requested segment,
the method further comprising a type sending step of sending information representing a usage type of the video data to the video supply apparatus,
wherein the information representing the usage type of the video data includes one of a first type that prioritizes minimizing delay rather than minimizing loss of the video data and a second type that prioritizes minimizing loss rather than minimizing delay of the video data.

14. A non-transitory computer-readable storage medium storing a program for causing a computer to execute the control method according to claim 12.

15. A non-transitory computer-readable storage medium storing a program for causing a computer to execute the control method according to claim 13.
